(19) United States
(12) Patent Application Publication
(10) Pub. No.: US 2026/0006413 A1
(43) Pub. Date: Jan. 1, 2026

(54) RESOURCE-DEPENDENT MESSAGE PRIORITIZATION

(71) Applicant: T-Mobile USA, Inc., Bellevue, WA (US)

(72) Inventor: Mehul Shah, Bellevue, WA (US)

(21) Appl. No.: 18/756,921

(22) Filed: Jun. 27, 2024

(51) Int. Cl. H04W 4/12; H04W 60/04; H04W 84/06

(52) U.S. Cl. CPC H04W 4/12; H04W 60/04; H04W 84/06

(57) ABSTRACT

A method for managing text message processing in a telecommunications network is disclosed. The method includes receiving a first text message from a first wireless device addressed to a second wireless device registered on the network. It is determined that the first wireless device is registered on a resource-constrained network. In response, a priority filter is used to ascertain that the first text message is a prioritized text message, which is then queued in a priority queue with a prioritized processing speed. A second text message from the first wireless device, also addressed to the second wireless device, is received. The priority filter ascertains that the second text message is a regular text message, which is queued in a regular queue with a regular processing speed that is less than the prioritized processing speed. The priority queue is cleared according to a priority processing period determined by the prioritized processing speed, while the regular queue is cleared according to a regular processing period determined by the regular processing speed. The regular processing period is greater than the priority processing period.

### BACKGROUND

Terrestrial communication relies on Earth-based infrastructure like cables and cellular networks, offering high data rates and low latency over shorter distances. Non-terrestrial network (NTN) deployment can use satellites, aircraft, and UAV (Unmanned Aerial Vehicles), including drones, balloons, kites, and High-Altitude Platform Stations (HAPS). NTNs provide connectivity in areas where terrestrial networks are unavailable or challenging to deploy, such as remote locations, or where connectivity has been disrupted. Satellite communication provides wide coverage but introduces higher latency and higher infrastructure costs.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates a system with resource-dependent message prioritization.

FIG. 4 is a block diagram that illustrates a method of resource-dependent message prioritization.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to resource-dependent message prioritization. In some implementations, resource-dependent message prioritization includes filtering a message (e.g., SMS, MMS, or RCS messages) sent over a telecommunication network to determine its “priority.” A message’s priority can determine when that message is delivered relative to another message. For example, a prioritized message can be delivered earlier than a regular message, even if the regular message is sent before the prioritized message.

In some implementations, priority filtering is triggered by a wireless device—either the sender or the target of the message—being registered on a resource-constrained network (e.g., a non-terrestrial network (NTN), or other network with limitations in bandwidth, power, or spectrum). The telecommunication network can determine if a network is resource constrained by performing an analysis of signal characteristics (e.g., frequency bands, latency, and signal strength) of the network. The telecommunication network can also analyze identification and registration information, routing information, geolocation information, or communication protocol of the network to determine a likelihood that the network is resource constrained.

The disclosed technology can provide a solution to the problem of limited capacity on resource-constrained networks. For example, on an NTN (e.g., a satellite communication network, high-altitude platform system, unmanned aerial vehicle, maritime communication system, or aeronautical communication system) capacity can be limited by power, bandwidth, distance from endpoints, or other factors. The available power to transmit can be limited by the power sources available to the NTN, which can include solar panels or batteries. Bandwidth can be limited compared to terrestrial networks, based on a regulated allocation of spectrum for NTN. Additionally, long distances between the NTN and its endpoints can lead to signal attenuation and loss, as well as latency, interference, and signal degradation when signals to and from the NTN encounter other signals and environmental factors such as weather conditions. By filtering those messages that are being sent by or to devices registered on a resource-constrained network (e.g., through a priority filter), the disclosed technology can limit the total amount of traffic on such a network and ensure a higher quality of service, fewer dropped calls, and reduced latency.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

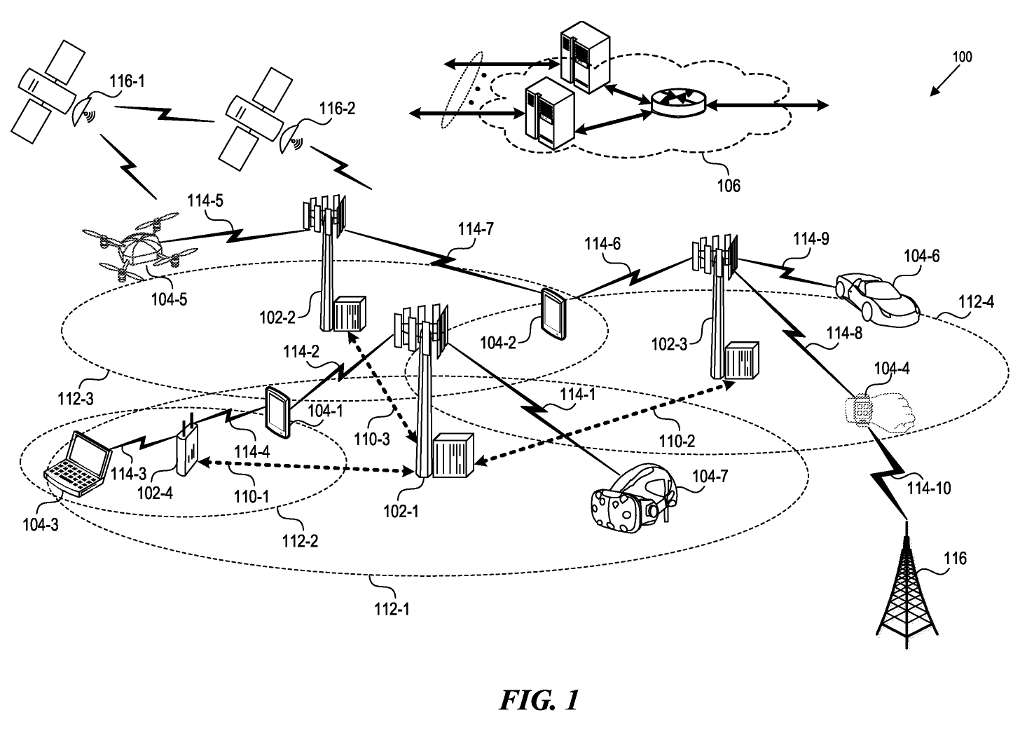

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

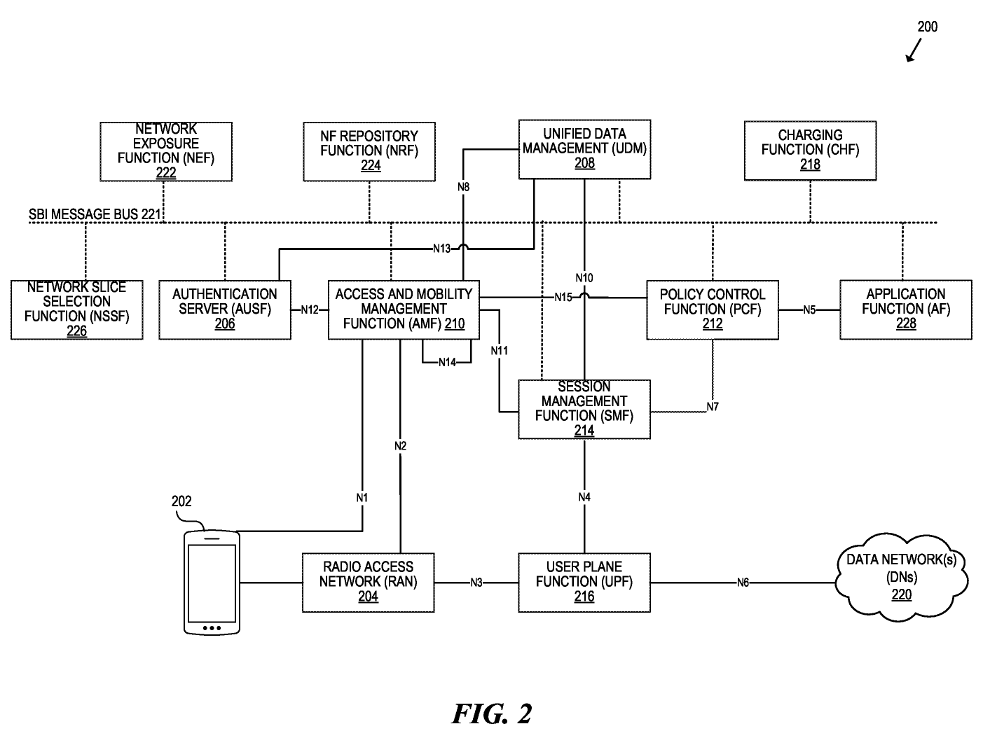

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service-Based Architecture (SBA) through a Service-Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Resource-Dependent Message Prioritization

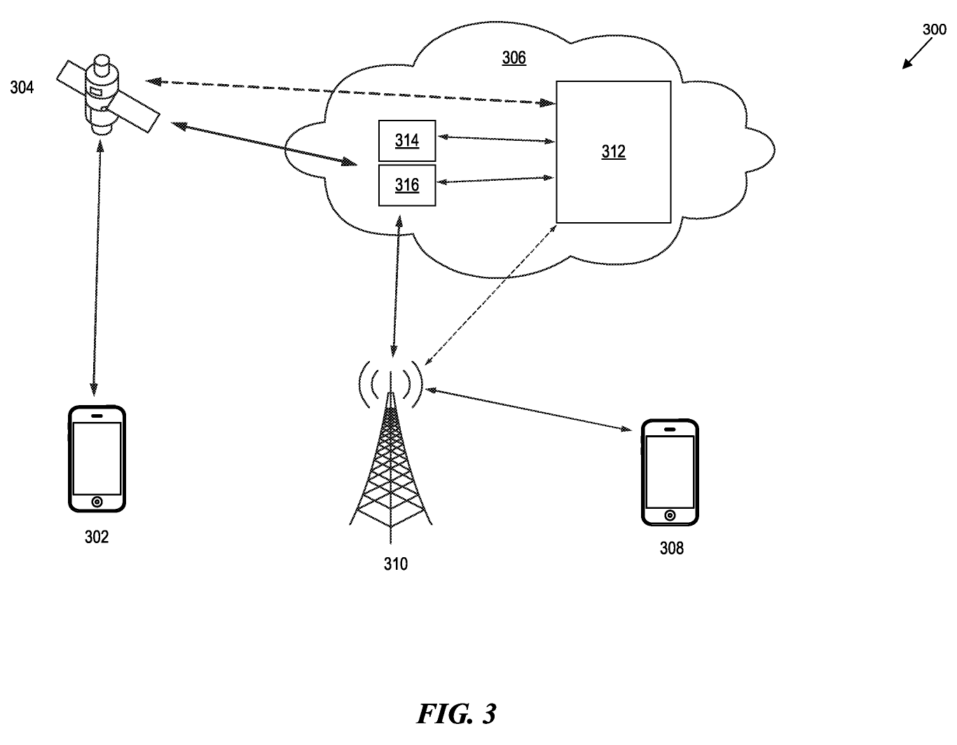

FIG. 3 is a block diagram that illustrates a system 300 with resource-dependent message prioritization. The system 300 can include a first wireless device 302 registered on a resource-constrained network 304. The first wireless device 302 can be a device (e.g., a mobile phone, laptop, tablet, wearable device, smartwatch, fitness tracker, notebook, portable computer, smart home device, industrial IoT device, modem, router, VoIP phone, video conferencing system, medical device, or Point of Sale system). The system 300 can receive a first message originating from the first device 302 and addressed to a second wireless device 308. The first message can be a text message (e.g., MMS, SMS, or RCS), or a voice call, a video call, an audio file, a video file, or an image file. The second wireless device can be registered on a telecommunications network 306. In some implementations, the resource-constrained network 304 includes a non-terrestrial network (NTN) (e.g., a satellite network, as illustrated), and the second wireless device 308 is registered to a terrestrial network 310 of the telecommunications network 306.

The system 300 can determine the first wireless device 302 is registered on a resource-constrained network 304. In an example implementation, the system 300 analyzes signal characteristics (e.g., frequency bands, latency, and signal strength) of the resource-constrained network 304. Additionally, the system 300 can analyze identification and registration information, routing information, geolocation information, or communication protocol of the resource-constrained network 304 to determine a likelihood that it is resource constrained.

The system uses a priority filter 312 to ascertain the first message is a prioritized message. The prioritized message can be a prioritized text message. This can be in response to determining the first wireless device 302 is registered on the resource-constrained network 304. Ascertaining the first message is a prioritized message can include at least one of: pre-processing the first message into a normalized message, tokenizing the normalized message, and comparing the tokens to a list of priority keywords. Pre-processing can include removing stop words and punctuation from the first message, lowercasing the first message, and correcting typos. Tokenizing can include splitting the normalized message into tokens based on stop characters (e.g., whitespace characters, punctuation marks, special characters, quotation marks, or custom delimiters). Alternatively, tokenizing can include splitting the normalized message into segments. Segments can include keywords, subjects, tokens, sentiments, frequencies, audio clips, video clips, bitmapped images, raster images, voice commands, gestures, actions, or expressions. Comparing the tokens to a list of priority keywords can include determining differences between the tokens and the keywords in the list. Additionally, such a process can also include ascertaining one or more tokens match one or more priority keywords from the list based on the differences. Determining differences can include calculating a Levenshtein distance between a token and a priority keyword or calculating ASCII encodings for a token and subtracting it from a priority encoding. Comparing these differences to a cutoff can then capture irregular or misspelled versions of priority keywords in a message.

Alternatively, the system 300 can compare the segments to a list of priority signals to determine differences and ascertain one or more segments match one or more priority signals from the list based on the differences. In some implementations, the list of priority signals or the list of priority keywords is published and available such that subscribers of the telecommunications of the network have read access to the list, whereas administrators of the system 300 have write access of the list. The list of priority keywords can include known or agreed-upon priority tags. These priority tags can be words (e.g., “help,” “urgent,” or “important”), or symbols (e.g., beginning a text with a sequence of “***”). The list of priority signals can be of an equivalent data type of the segments with which they are being compared. In some implementations, the list of priority signals includes phone numbers which have been marked by the sender or the recipient as being important.

Alternatively, ascertaining the first message is a prioritized message can include ascertaining a score for the first message and comparing the score to a threshold. In some implementations, the score is a priority score, and the threshold is a priority threshold. In some implementations, the priority filter 312 includes a model which has been trained to output scores for messages based on a history of previous messages with known scores. In some implementations, the model is a prioritizing model. Such a model can include a neural network, a decision tree, a probability distribution, a logistic regression, or a Bayesian model. In such implementations, the first message is provided as an input to the model, and the model outputs a score for the first message based on contents of the first message. In establishing the first message as the prioritized message by comparing the score to the threshold, the score can satisfy or exceed the threshold. The priority threshold can include a parameter that is determined by the model (e.g., a learned parameter), or parameter that is set by a domain expert (e.g., a hyperparameter), or a parameter that is learned from an error curve. In some implementations, the error curve can be tuned by the domain expert to adjust the priority threshold to favor one type of error over another (e.g., precision versus recall).

The model can also receive as input, and be trained on, other features that are associated with a message and influence a priority of the message. These other features can include time of day and time zone of the sender and the recipient, as well as the phone number of the sender or the recipient, and the number of previous calls made to the sender or the recipient, as well as a length of those previous calls. Other features can also include network characteristics, such as distance to the endpoint, traffic, bandwidth, and power. The score can also be influenced by a surcharge amount, paid by the sender or the recipient of the message to the telecommunication network, either as a one-time fee or as part of a subscription service.

Alternatively, ascertaining the first message is a prioritized message can include receiving a priority flag (e.g., an RCS reaction, or a long-press command) from the sender of the first message, in which case the priority filter recognizes the priority flag as having an association with the first message. Such recognition can occur where the first message includes a first identifier and the priority flag is received by the priority filter 312 as part of a first metadata sent from the first wireless device 302 to the second wireless device 308. The system 300 can compare the first identifier to the second identifier to determine a match. From this, the priority filter 312 can ascertain the priority flag modifies the first message based on the association between the first metadata and the first message.

The system 300 can queue the prioritized message in a priority queue 314. The priority queue 314 can be a collection that follows a First In, First Out (FIFO) principle, or a stack, array, linked list, double-ended queue, hash table, tree, graph, heap, buffer, bloom filter, or some combination of the aforementioned data structures. The priority queue 314 can be sorted according to priority scores, in which case a message with a highest score is at a front of the priority queue 314, and a message with a lowest score at a back of the priority queue 314. The system 300 can receive a second message originating from the first wireless device 302 and addressed to the second wireless device 308. The second message can be a text message or other form of communication as described above, with regard to the first message. The system 300 can ascertain the second message is a regular message, using the priority filter 312. In some implementations, the regular message is a regular text message. Where the system 300 ascertains the second message is the regular message by using the priority filter 312, the priority filter 312 can output a score that is less than the priority threshold.

The system 300 can queue the regular message in a regular queue 316. In some implementations, the priority queue 314 has a prioritized processing speed, the regular queue 316 has a regular processing speed, and the regular processing speed is less than the prioritized processing speed.

The system 300 can clear the priority queue 314 in accordance with a priority processing period determined by the prioritized processing speed. In some implementations, clearing the priority queue 314 includes delivering the prioritized message to the second device 308. Alternatively, the system 300 can clear the priority message in accordance with a priority processing period. Clearing the priority message can include delivering the priority message to the first device, or queuing the priority message for delivery to the first device when the first device connects to a terrestrial network.

They system 300 can clear the regular queue 316 in accordance with a regular processing period determined by the regular processing speed. In some implementations, the regular processing period is greater than the priority processing period. Clearing the regular queue can include dropping the regular message or delivering the regular message to the second wireless device 308. Alternatively, the system can clear the regular message in accordance with a regular processing period. Clearing the regular message can include dropping the regular message, delivering the regular message to the first device, or queuing the regular message for delivery to the first device when the first device connects to a terrestrial network.

In some implementations, the system 300 includes a non-transitory, computer-readable storage medium that includes instructions which are recorded on the computer-readable storage medium. In some implementations, the system 300 includes at least one hardware processor and at least one non-transitory memory. The non-transitory memory can store the instructions. The instructions, when executed by at least one data processor or hardware processor of the system 300, can cause the system 300 to perform the operations described herein.

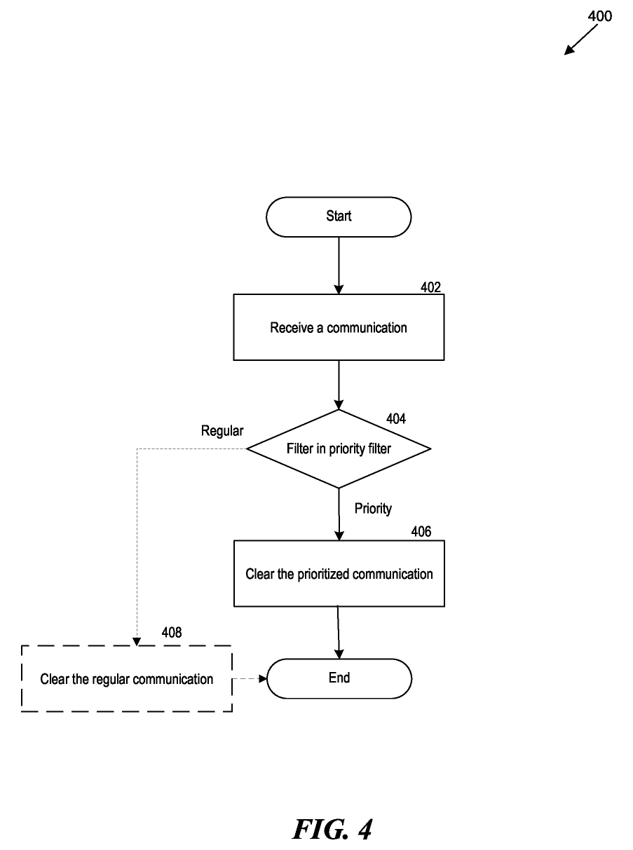

FIG. 4 is a block diagram that illustrates a method 400 of resource-dependent message prioritization. The method 400 includes a first box 402, which includes receiving a communication. The communication can include a voice call, a video call, a text message, an audio file, a video file, or an image file.

The method 400 includes a second box 404: filtering the communication in a priority filter. Filtering the communication can include labeling it with a binary score (e.g., “priority” or “regular”) or assigning the communication a continuous score, which is compared against a cutoff to determine if the method 400 prioritizes the communication. Ascertaining the communication is a prioritized communication can include pre-processing the communication into a normalized communication, splitting the normalized communication into segments, and ascertaining that one or more segments match one or more priority signals based on a comparison. The segments can include keywords, subjects, tokens, sentiments, frequencies, audio clips, video clips, voice commands, gestures, actions, or expressions.

Ascertaining the communication is a prioritized communication can include ascertaining a score for the communication by providing the communication as an input to a model. In some implementations, the model has been trained to output scores for communications based on previous communications with known scores. Also, the method 400 can compare the score to a threshold; if the score satisfies or exceeds the threshold, the method 400 designates the communication as a prioritized communication. If the score is less than the threshold, the method 400 treats the communication as a regular communication. In such implementations, the priority filter can include one or more of a language model, an object detection model, an action detection model, a facial expression recognition model, and an automatic speech recognition model.

Ascertaining the communication is a prioritized communication can include receiving a priority flag. In such implementations, the method 400 determines the priority flag modifies the communication based on an identifier shared by both the priority flag and the communication.

The method 400 includes a third box 406: clearing the prioritized communication(s). Clearing the prioritized communication can include delivering the prioritized communication to an NTN or queuing the prioritized communication for a delivery. In the latter case, the prioritized communication can be held until the recipient registers on a terrestrial network. Clearing the prioritized communication(s) can occur in accordance with a prioritized processing period.

The method 400 can include a fourth box 408: clearing the regular communication(s). Clearing the regular communication(s) can include dropping the regular communication(s), delivering the regular communication(s) to an NTN, or queuing the regular communication(s) for a delivery. Clearing the regular communication(s) can occur in accordance with a regular processing period. In such implementations, the prioritized processing period is less than the regular processing period.

### Computer System

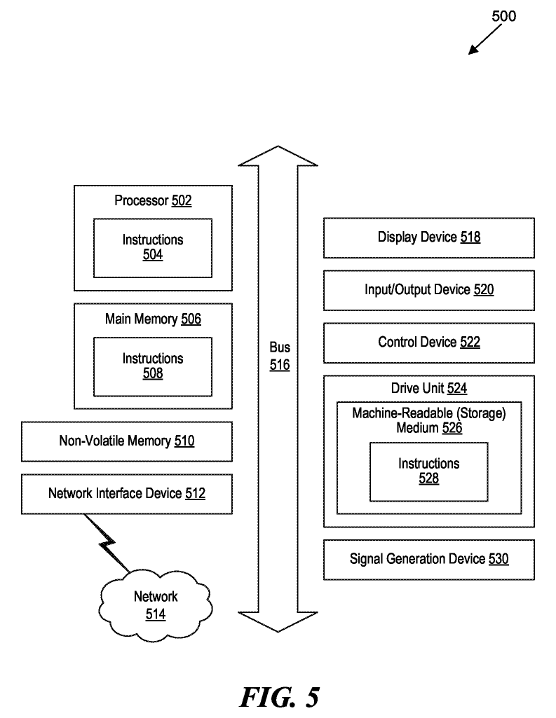

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps or employ systems having blocks in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above and any that may be listed in accompanying filing papers are incorporated herein by reference in their entireties, except for any subject matter disclaimers or disavowals and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A non-transitory, computer-readable storage medium comprising instructions recorded thereon, wherein the instructions when executed by at least one data processor of a system, cause the system to:
receive a first text message originating from a first wireless device and addressed to a second wireless device registered on a telecommunications network;
determine the first wireless device is registered on a resource-constrained network;
in response to determining the first wireless device is registered on the resource-constrained network, ascertain, using a priority filter, that the first text message is a prioritized text message;
queue the prioritized text message in a priority queue having a prioritized processing speed;
receive a second text message originating from the first wireless device and addressed to the second wireless device;
ascertain, using the priority filter, that the second text message is a regular text message;
queue the regular text message in a regular queue having a regular processing speed less than the prioritized processing speed;
clear the priority queue in accordance with a priority processing period determined by the prioritized processing speed; and
clear the regular queue in accordance with a regular processing period determined by the regular processing speed,
wherein the regular processing period is greater than the priority processing period.

2. The non-transitory, computer-readable storage medium of claim 1, wherein to clear the priority queue comprises causing the system to:
cause delivery of the prioritized text message to the second wireless device on the telecommunications network.

3. The non-transitory, computer-readable storage medium of claim 1, wherein to clear the regular queue comprises causing the system to:
drop the regular text message, or
cause delivery of the regular text message to the second wireless device on the telecommunications network.

4. The non-transitory, computer-readable storage medium of claim 1, wherein the resource-constrained network is a non-terrestrial network (NTN), and the second wireless device is registered to a terrestrial network of the telecommunications network.

5. The non-transitory, computer-readable storage medium of claim 1, wherein to ascertain that the first text message is the prioritized text message comprises causing the system to:
pre-process the first text message into a normalized text message by removing stop words and punctuation from the first text message, lowercasing the first text message, and correcting typos;
tokenize the normalized text message into tokens by splitting the normalized text message based on stop characters;
compare the tokens to a list of priority keywords to determine differences; and
ascertain one or more tokens match one or more priority keywords from the list based on the differences.

6. The non-transitory, computer-readable storage medium of claim 1, wherein to ascertain that the first text message is the prioritized text message comprises causing the system to:
ascertain a priority score for the first text message by providing the first text message as an input to a prioritizing model, wherein the prioritizing model has been trained to output priority scores for text messages based on a history of previous text messages with known priority scores; and
compare the priority score to a priority threshold, wherein the priority score satisfies or exceeds the priority threshold.

7. The non-transitory, computer-readable storage medium of claim 1, wherein the first text message includes a first identifier, and wherein to ascertain the first text message is the prioritized text message comprises causing the system to:
receive a first metadata from the first wireless device and addressed to the second wireless device, wherein the first metadata includes a priority flag and a second identifier;
compare the first identifier to the second identifier to determine a match;
associate the first metadata with the first text message based on the match between the second identifier and the first identifier; and
ascertain the priority flag modifies the first text message based on an association between the first metadata and the first text message.

8. A system comprising:
at least one hardware processor; and
at least one non-transitory memory storing instructions, which, when executed by the at least one hardware processor, cause the system to:
receive a first message addressed to a first device registered on a resource-constrained network;
ascertain the first message is a priority message using a priority filter;
receive a second message addressed to the first device;
ascertain the second message is a regular message using the priority filter;
clear the priority message in accordance with a priority processing period; and
clear the regular message in accordance with a regular processing period,
wherein the regular processing period is greater than the priority processing period.

9. The system of claim 8, wherein the resource-constrained network includes an NTN, and wherein to clear the priority message comprises causing the system to:
cause delivery of the priority message to the first device on the NTN, or
queue the priority message for a delivery to the first device when the first device connects to a terrestrial network.

10. The system of claim 8, wherein the resource-constrained network includes an NTN, and wherein to clear the regular message comprises causing the system to:
drop the regular message,
cause delivery of the regular message to the first device on the NTN, or
queue the regular message for a delivery to the first device when the first device connects to a terrestrial network.

11. The system of claim 8, wherein to ascertain that the first message is the priority message comprises causing the system to:
pre-process the first message into a normalized message;
split the normalized message into segments;
compare the segments to a list of priority signals to determine differences; and
ascertain one or more segments match one or more priority signals from the list based on the differences.

12. The system of claim 8, wherein to ascertain that the first message is the priority message comprises causing the system to:
ascertain a score for the first message by providing the first message as an input to a model, wherein the model has been trained to output scores for messages based on previous messages with known scores; and
compare the score to a threshold, wherein the score satisfies or exceeds the threshold.

13. The system of claim 8, wherein to ascertain the first message is the priority message comprises causing the system to:
receive a priority flag addressed to the first device; and
ascertain the priority flag modifies the first message based on an association between the priority flag and the first message.

14. The system of claim 11, wherein the segments comprise at least one of:
keywords,
subjects,
tokens,
sentiments,
frequencies,
audio clips,
video clips,
voice commands,
gestures,
actions, or
expressions.

15. A method comprising:
receiving a communication;
ascertaining the communication is a prioritized communication using a priority filter; and
clearing the prioritized communication in accordance with a prioritized processing period,
wherein the prioritized processing period is less than a regular processing period.

16. The method of claim 15, wherein clearing the prioritized communication comprises:
causing delivery of the prioritized communication to an NTN, or
queuing the prioritized communication for a delivery.

17. The method of claim 15, wherein ascertaining the communication is the prioritized communication comprises:
pre-processing the communication into a normalized communication;
splitting the normalized communication into segments; and
ascertaining one or more segments match one or more priority signals based on a comparison.

18. The method of claim 15, wherein ascertaining the communication is the prioritized communication comprises:
ascertaining a score for the communication by providing the communication as an input to a model, wherein the model has been trained to output scores for communications based on previous communications with known scores; and
comparing the score to a threshold, wherein the score satisfies or exceeds the threshold.

19. The method of claim 15, wherein ascertaining the communication is the prioritized communication comprises:
receiving a priority flag; and
ascertaining the priority flag modifies the communication based on a common identifier shared by the priority flag and the communication.

20. The method of claim 15, wherein the communication includes at least one of:
a voice call,
a video call,
a text message,
an audio file,
a video file, or
an image file.
